(19) United States
(12) Patent Application Publication
(10) Pub. No.: US 2014/0210129 A1
(43) Pub. Date: Jul. 31, 2014

(54) METHOD FOR MANUFACTURING CARBON ELECTRODE MATERIAL

(71) Applicant: Corning Incorporated, Corning, NY (US)

(72) Inventors: Obiefuna Chukwuemeka Okafor, Painted Post, NY (US); Kamjula Pattabhirami Reddy, Corning, NY (US); James William Zimmermann, Corning, NY (US)

(73) Assignee: Corning Incorporated, Corning, NY (US)

(21) Appl. No.: 14/161,191

(22) Filed: Jan. 22, 2014

Related U.S. Application Data
(60) Provisional application No. 61/756,625, filed on Jan. 25, 2013.

(51) Int. Cl. H01M 4/04; B01F 7/00

(52) U.S. Cl. CPC H01M 4/0411; B01F 7/00416
USPC 264/175; 366/301

(57) ABSTRACT

A method of extruding a dry mixture includes providing mixing materials to a twin screw extruder. The mixing materials are substantially dry and may include a substantially unfibrillated binder and a carbon material. The method includes extruding the mixing materials via a twin screw extruder to form an extruded mixture that is substantially dry. In one embodiment, the substantially dry mixture exiting the extruder may be further processed to form an electrode material, such as by a calendaring step.

### CROSS-REFERENCE TO RELATED APPLICATIONS

This application claims the benefit of priority under 35 U.S.C. §119 of U.S. Application Ser. No. 61/756,625 filed on Jan. 25, 2013, the entire content of which is hereby incorporated by reference.

### FIELD OF THE DISCLOSURE

The disclosure relates to a method for manufacturing a carbon electrode material. In particular, the disclosure relates to a method and apparatus for manufacturing a carbon electrode material that includes a carbon material and a fibrillated binder.

### BACKGROUND

Carbon electrode materials may be used, for example, in high performance double-layer capacitors. One type of capacitor is an ultracapacitor, also known as a supercapacitor, which is an electrochemical device that has highly reversible charge-storage processes per unit volume and unit weight. Batteries are common energy storage devices that provide portable power due to their potential for a relatively high energy density but are limited by their relatively low power density and a relatively low number of charging cycles. Capacitors generally have relatively higher energy transfer rates than batteries but are limited by a relatively low energy storage capacity. Ultracapacitors have a high energy density and high rate at which energy may be transferred into or out of the device per weight or volume.

Ultracapacitors may also be desirable because they may not contain hazardous or toxic materials and, therefore, may be easy to dispose of. Additionally, they may be utilized in large temperature ranges, and they have demonstrated cycle lives in excess of 500,000 cycles. Ultracapacitors may be used in a broad spectrum of electronic equipment such as, for example, cell phones, fail-safe positioning in case of power failures, and electric vehicles due to their advantageous combination of high energy transfer rate and recharging capabilities. Ultracapacitors may include a carbon electrode material, which may be made from a mixture of materials. Conventional manufacturing processes typically are non-continuous, batch processes that include several steps.

Thus, there exists a need for carbon electrode materials and related products that are less costly, environmentally friendly, and require less processing while still capable of producing reliable, homogeneous electrodes. Moreover, there is a need for methods to make carbon electrodes having these desirable properties.

### SUMMARY

In accordance with the detailed description and various exemplary embodiments described herein, the disclosure relates to processes to mix substantially dry materials using mixing equipment that applies one or more of shear, compression, and tensile forces to the dry materials.

In various exemplary embodiments, a method of forming a carbon electrode material includes providing substantially dry mixing materials to a twin screw extruder. The mixing materials may comprise substantially unfibrillated binder and a carbon material. The method may further include extruding the mixing materials via a twin screw extruder to form a substantially dry carbon electrode material comprising a fibrillated binder.

In another exemplary embodiment, a method of extruding a dry mixture includes providing mixing materials to a twin screw extruder. The mixing materials are substantially dry. The method may further include extruding the mixing materials via the twin screw extruder to form an extruded mixture that is substantially dry.

In another exemplary embodiment, a method of forming a carbon electrode material includes providing substantially dry mixing materials to a twin screw extruder. The mixing materials may include a substantially unfibrillated binder and a carbon material. The mixing materials may be extruded via a twin screw extruder to form a substantially dry carbon electrode material comprising a fibrillated binder. The method may further include calendaring the substantially dry carbon electrode material into an electrode.

### BRIEF DESCRIPTION OF THE DRAWINGS

The accompanying drawings are included to provide a further understanding of the invention, and are incorporated in and constitute a part of this specification. The drawings are not intended to be restrictive of the disclosure, but rather are provided to illustrate exemplary embodiments of the invention and, together with the description, serve to explain the principles of the invention.

FIG. 1 is side cross-sectional view of an exemplary embodiment of a twin screw extrusion device;

FIG. 2 is a perspective view of an exemplary embodiment of a segmented screw;

FIG. 3 is a top view of an exemplary embodiment of a flighted screw portion;

FIG. 4 is a side view of an exemplary embodiment of a kneading block portion of a screw;

FIG. 5 is a side view of an exemplary embodiment of a kneading block portion of a screw;

FIG. 6 is a side view of an exemplary embodiment of a kneading block portion of a screw;

FIG. 7 is a side cross-sectional view of an electrode produced by a conventional ball milling process; and

FIG. 8 is a side cross-sectional view of an exemplary embodiment of an electrode produced by a dry screw extrusion process.

### DETAILED DESCRIPTION

It is to be understood that both the foregoing general description and the following detailed description are exemplary and explanatory only and are not restrictive of the disclosure. Other embodiments will be apparent to those skilled in the art from consideration of the specification and practice of the embodiments disclosed herein. It is intended that the specification and examples be considered as exemplary only, with the true scope and spirit of the invention being indicated by the claims.

This disclosure relates to processes to mix substantially dry materials using mixing equipment that applies one or more of shear, compression, and tensile forces to the dry materials. The disclosure further relates to a dry process of mixing substantially dry particles and dry unfibrillated binder using mixing equipment. The mixing equipment may be an auger, which may also be referred to as a screw extruder. The binder may be fibrillated by the mixing equipment, which provides one or more of shear, compression, and tensile forces. Unlike milling, the mixing equipment, such as a screw extruder, applies shear to mixing materials and does not substantially rely upon impacting the mixing materials, Such mixing equipment may advantageously provide enhanced control of the fibrillation of a binder, which may provide less variability in mixed materials when compared to the output of conventional processes.

Various materials may be prepared by a process of extruding dry materials. According to an exemplary embodiment, the extruded materials may include particulates held by a binder. According to an exemplary embodiment, the dry mixing materials may include one or more of, for example, a carbon material, a binder, carbon black, talc particulates, precursors for pharmaceutical medicines or products, and mixtures thereof. According to an exemplary embodiment, two types of polytetrafluoroethylene (PTFE) may be provided as mixing materials. For instance, low molecular weight PTFE may be mixed with high molecular weight PTFE. The binder used to hold particulates may be unfibrillated materials that form fibrils as a result of the extrusion process, which applies one or more of shear, compression, and tensile forces to the binder during the extrusion process. According to an exemplary embodiment, mixing materials provided to an extrusion device may be substantially dry so that an extruded mixture produced by the extrusion device is substantially dry.

Materials made by the processes described herein may be used in various devices. One such device is an ultracapacitor. An ultracapacitor includes two electrodes separated from one another by a porous separator. Due to its location between the electrodes, the separator minimizes or prevents stray electric current that could cause a short between the electrodes. The electrodes and the separator may be immersed in an electrolyte that allows a flow of ionic current between the electrodes and through the separator. Ultracapacitors advantageously provide increased capacitance due to a combination of high surface area of a carbon material in the electrodes with small distances between opposing charges.

The electrodes of an ultracapacitor may be from a carbon electrode material. Mixing materials may be provided to an extrusion device to produce the carbon electrode material. According to an exemplary embodiment, carbon electrode material may be not be a final product and may be further processed. For instance, carbon electrode material may be further processed to form an electrode material for an electrode, such as an electrode of an ultracapacitor. The mixing materials provided to make the carbon electrode material may comprise both solid and liquid components, although the mixing materials are preferably dry. Further, the carbon electrode material is preferably dry in its extruded form.

According to an exemplary embodiment, a carbon electrode material comprises a carbon material and at least one binder material. Therefore, mixing materials provided to an extrusion device may include a carbon material and at least one binder material that are extruded to provide the described carbon electrode material. Mixing materials selected to form a carbon electrode material may be compatible with electrolytes used for electrodes, such as acetonitrile-based electrolyte. According to an exemplary embodiment, the mixing materials provided to the extrusion device may be substantially dry to produce a carbon electrode material that is substantially dry, as will be discussed below.

Carbon material for a carbon electrode material may advantageously have a relatively high surface area and conductance to provide desirable electrical properties for an electrode. According to an exemplary embodiment, a carbon material provided as a mixing material may be activated carbon. Thus, activated carbon may be provided as a mixing material that may be extruded with a binder to provide a carbon electrode material that includes the activated carbon and the binder. As used herein, the term “activated carbon,” and variations thereof, is intended to include carbon that has been processed to make it extremely porous and, thus, to have a high specific surface area. For example, activated carbon may be characterized by a high specific surface area, as determined by the BET method, ranging from 300 to 2500 m²/g. According to an exemplary embodiment, activated carbon may be in a powder form having an average particle diameter ranging from about 1 μm to about 10 μm. In another example, activated carbon may have an average particle diameter of about 3 μm to about 8 μm. In another example, activated carbon may have an average particle diameter of about 5 μm. Activated carbon for use as a mixing material includes, but is not limited to, those marketed under the trade name Activated Carbon by Kuraray Chemical Company Ltd, of Osaka, Japan, Carbon Activated Corporation of Compton, Calif., and General Carbon Corporation of Paterson, N.J.

In various embodiments, the mixing materials provided to an extrusion device may comprise at least 70 wt % of activated carbon. As used herein, reference to weight percent for solids is relative to total solids loading. In other words, the totality of mixing materials provided to an extrusion device, whether mixed prior to being provided to the extrusion device or added during the extrusion process, includes at least 70 wt % of activated carbon. In another example, the mixing materials comprise at least 80 wt % of activated carbon. In another example, the mixing materials comprise at least 85 wt % of activated carbon.

At least one binder may be utilized to provide cohesion between structures or components of a carbon electrode material. For instance, a binder may provide cohesion between the carbon material of a carbon electrode material. One method for a binder to provide cohesion between components of a carbon electrode material is for the binder to have an at least partially fibrillated structure. The fibrils of a fibrillated structure may provide a supporting structure or matrix for components of a carbon electrode material, such as the carbon material of a carbon electrode material.

According to an exemplary embodiment, the binder is substantially free of fibrillation before extrusion. Thus, the at least one binder may be provided as a mixing material to an extrusion device in a substantially unfibrillated form. As used herein, the phrases “substantially unfribrillated” and “substantially free of fibrillation,” and variations thereof, are intended to mean that the binder has not been worked prior to extrusion to develop the fibrous nature of the binder.

The binder material may be chemically inert and electrochemically stable. Further, the binder may be capable of forming an at least partially fibrillated structure via the extrusion process. According to an exemplary embodiment, at least one binder for a carbon electrode material comprises a polymer capable of forming an at least partially fibrillated structure. According to an exemplary embodiment, the at least one binder may be PTFE, which is particularly stable in electrolyte solvents and is capable of forming a fibrillated structure when subjected to the stresses provided by an extrusion process. PTFE may be provided as particulates or granules that are substantially unfibrillated. As used herein with regard to PTFE, “substantially unfibrillated” is intended to mean that the PTFE particles have not been worked prior to or during preparation of the PTFE mixing material to develop the fibrous nature of the material, i.e., they are not yet fibrous. Thus, substantially unfibrillated PTFE may be provided as a mixing material to an extrusion device. According to an exemplary embodiment, unfibrillated PTFE and activated carbon may be provided as mixing materials to an extrusion device to produce a carbon electrode material that includes the activated carbon and fibrillated PTFE. Substantially unfibrillated PTFE for use as a mixing material includes, but is not limited to, those products marketed under the trade name Polytetrafluoroethylene by Sigma-Aldrich Corp. of St. Louis, Mo. and by Alfa Aesar, a division of Johnson Matthey, of Ward Hill, Mass.

According to an exemplary embodiment, the at least one binder material may be a substantially unfibrillated PTFE having molecular weight ranging from about 1×10⁶ g/mol to about 10×10⁶ g/mol. According to another exemplary embodiment, the molecular weight may range from about 2×10⁶ g/mol to about 6×10⁶ g/mol. According to another exemplary embodiment, the molecular weight may be about 5×10⁶ g/mol.

According to an exemplary embodiment, the mixing materials provided to an extrusion device may comprise from about 0.1 wt % to about 20 wt % of at least one binder. In other words, the totality of mixing materials provided to an extrusion device, whether mixed prior to being provided to the extrusion device or added during the extrusion process, includes about 0.1 wt % to about 20 wt % of at least one binder. According to another embodiment, the mixing materials may comprise about 1 wt % to about 10 wt %. According to another embodiment, the mixing materials may comprise about 8 wt % of at least one binder.

According to an exemplary embodiment, mixing materials, and therefore the carbon electrode material produced from the mixing materials, may include other additives. For instance, mixing materials may include, for example, carbon black, water, solvents, lubricants, plasticizers, fibers, nanotubes, dispersible powder, mixtures thereof, one or more additional binders, moisture absorbers, and other additives used for carbon electrode materials. In various embodiments, mixing materials provided to an extrusion device may comprise an amount of at least one additive ranging from about 0.01 wt % to about 5 wt %. In another example, the mixing materials provided to an extrusion device may comprise an amount of at least one additive of about 0.1 wt % to about 2 wt %. In another example, the mixing materials provided to an extrusion device may comprise an amount of at least one additive of about 0.5 wt %.

According to an exemplary embodiment, mixing materials provided to an extrusion device may comprise a carbon material, at least one substantially unfibrillated binder, and carbon black. As used herein, the term “carbon black” is intended to include forms of amorphous carbon with a high specific surface area. For example, carbon black may be characterized by a high BET specific surface area, for example ranging from about 25 m²/g to about 2000 m²/g. In another example, carbon black may have a specific surface area ranging from about 200 m²/g to about 1800 m²/g. In another example, carbon black may have a specific surface area ranging from about 1400 m²/g to about 1600 m²/g.

While various features, elements or steps of particular embodiments may be disclosed using the transitional phrase “comprising,” it is to be understood that alternative embodiments, including those that may be described using the transitional phrases “consisting” or “consisting essentially of” are implied. Thus, for example, implied alternative embodiments to a mixing material that comprises activated carbon and PTFE include embodiments where a mixing material consists of activated carbon and PTFE and/or embodiments where a mixing material consists essentially of activated carbon and PTFE.

Carbon black may be a powder having an average particle diameter ranging from, for example, about 1 μm to about 40 μm. In another example, the carbon black powder may have an average particle diameter of about 10 μm to about 25 μm. In another example, the carbon black powder may have an average particle diameter of about 17 μm. Carbon black for use in the mixing materials include, but are not limited to, those marketed under the trade name BLACK PEARLS® 2000 by Cabot Corporation of Boston, Mass., VULCAN® XC 72 by Cabot Corporation of Boston, Mass., and PRINTEX® L6 by Evonik of Essen, Germany.

According to an exemplary embodiment, mixing materials provided to an extrusion device may comprise an amount of carbon black ranging from about 0.1 wt % to about 15 wt %. According to another embodiment, mixing materials provided to an extrusion device may comprise an amount of carbon black ranging from about 1 wt % to about 10 wt %. According to another embodiment, mixing materials provided to an extrusion device may comprise an amount of carbon black of about 5 wt %.

According to an exemplary embodiment, mixing materials provided to an extrusion device may further comprise at least a second binder material. In at least one embodiment, the at least one second binder material may be chosen from styrene-butadiene rubber copolymers, such as those marketed under the commercial name LICO® LHB-108P as a water-based dispersion by Lico Technology Corporation of Taiwan.

For example, the mixing materials provided to an extruding device may comprise an amount of at least one second binder material ranging from about 0.1 wt % to about 5 wt %. According to another example, the mixing materials provided to an extruding device may comprise an amount of at least one second binder material ranging from about 1 wt % to about 3 wt %. According to another example, the mixing materials provided to an extruding device may comprise an amount of at least one second binder material of about 1.5 wt %.

According to an exemplary embodiment, the mixing materials provided to an extruding device may include one or more moisture absorbers. A moisture absorber may be a carboxymethylcellulose, such as, for example, those marketed under the trade name Carboxylmethylcellulose (CMC) by Sigma-Aldrich Corp. of St. Louis, Mo. and EAGLE® CMC by Anqiu Eagle Cellulose Company of China.

Some additives, such as water, solvents, lubricants, electrolytes, liquid hydrocarbons, and other additives, may provide a liquid content to the mixing materials. Such an additive that provides a liquid content may be present as a carrier to affect the fluidity of the mixing materials during a mixing process. As used herein, the term “carrier,” and variations thereof, is intended to mean a material that aids the transport or flow of mixing materials. Thus, a carrier or other additive that provides a liquid content may make the mixing materials wet and conducive to flow through mixing equipment.

However, when the mixing materials include a liquid content, a manufacturing process for mixed material typically includes an additional step of removing the liquid content, such as via a drying step after extrusion. The additional step to remove the liquid imposes an additional cost and increases manufacturing time. Therefore, it would be beneficial to provide a manufacturing process that minimizes or avoids a drying step.

Although the embodiments described herein may optionally include liquid in the mixing materials, the mixing materials are preferably substantially dry. Therefore, according to an exemplary embodiment, mixing materials provided to an extrusion device are substantially dry. For example, water, lubricant, electrolyte, solvent, liquid hydrocarbons, carriers, and other materials providing liquid content may be substantially absent from mixing materials that are substantially dry. In another example, substantially dry mixing materials may not include a plasticizer content besides any binder included in the mixing materials. Thus, mixing materials may include about 0 wt % plasticizer besides a binder, such as PTFE. By providing substantially dry mixing materials, a carbon electrode material produced by the extrusion process may in turn be substantially dry and not require a process to remove liquid or otherwise dry the carbon electrode material.

According to an exemplary embodiment, substantially dry mixing materials may have a maximum liquid content of about 5 wt %. In other words, a totality of mixing materials provided to a mixing device, whether prior or during the mixing process, has the maximum liquid content. According to another exemplary embodiment, substantially dry mixing materials may have a maximum liquid content of about 4 wt %. According to another exemplary embodiment, substantially dry mixing materials may have a maximum liquid content of about 3 wt %. According to another exemplary embodiment, substantially dry mixing materials may have a maximum liquid content of about 2 wt %. According to another exemplary embodiment, substantially dry mixing materials may have a maximum liquid content of about 1 wt %. According to another exemplary embodiment, substantially dry mixing materials may have a maximum liquid content of about 0.5 wt %. According to another exemplary embodiment, substantially dry mixing materials may have a liquid content of about 0 wt %.

Conventional processes used to mix materials include ball milling, jet milling, and other mixing processes. Although these processes may successfully mix materials, it may be desirable to provide an improved mixing process. According to an exemplary embodiment, substantially dry mixing materials may be mixed by a screw extruder. By utilizing substantially dry mixing materials, a drying step may be avoided or minimized, which advantageously reduces the cost and process time in comparison to conventional processes that use wet mixing materials. Further, mixing substantially dry mixing materials with a screw extruder may provide a mixed material with improved uniformity, such as improved microstructural uniformity. For instance, when the mixing materials include a particulate material and a binder, the particulate material may be more uniformly distributed within the binder than in materials mixed by the conventional processes, such as ball milling or jet milling. Thus, extruding dry mixing materials with a screw extruder may advantageously provide a mixed material with an improved uniformity in comparison to materials mixed by conventional processes.

Using a screw extruder to mix substantially dry mixing materials may provide additional advantages. For instance, a temperature of the extruding process may be readily controlled by heating and cooling screw extruder components. This advantageously provides improved control of energy management of the extrusion process, which in turns provides excellent quality control for the mixed product. For instance, the energy applied to the extruded material, such as from friction arising due to particle-to-particle interaction between mixing materials and/or with screw extruder components, may be monitored via the power of a motor driving the screw(s) of the extruder. According to an exemplary embodiment, components of the screw extruder, such as the barrel and/or screw(s), may be heated or cooled to control the temperature of mixing materials.

A screw extruder may provide other advantages, such as providing a continuous process to mix materials that improves the processing speed and capacity for a mixing process. In addition, a screw extruder may advantageously provide a process that reproducibly provides a mixed material with a uniform microstructure.

A screw extruder may include one or more augers, also referred to as screws. According to an exemplary embodiment, a screw extruder may be a twin screw extruder. However, a screw extruder is not limited to a twin screw extruder and may have a single screw, three screws, or other numbers of screws.

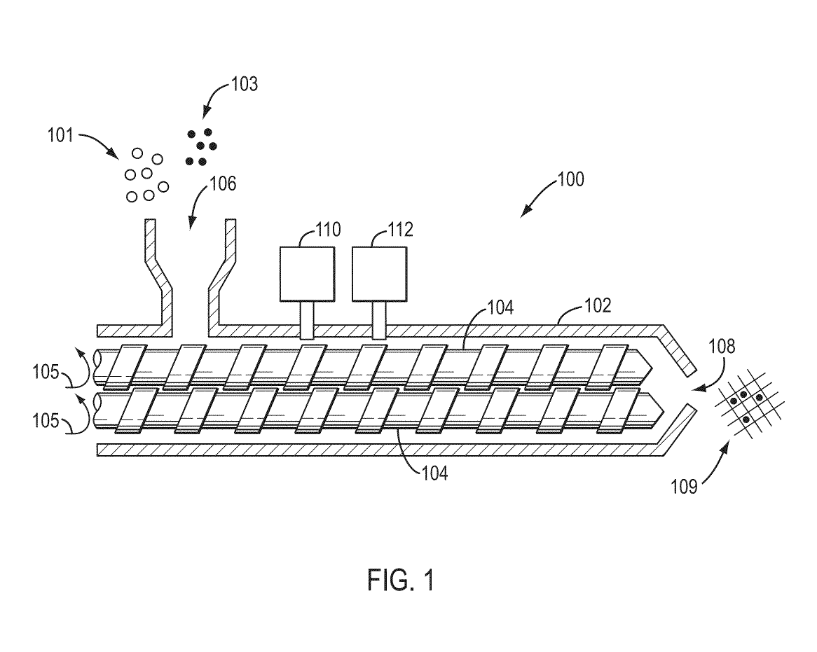

Turning to FIG. 1, an exemplary embodiment of a twin screw extruder 100 is shown. As shown in FIG. 1, screw extruder 100 may include a barrel 102 and two screws 104. Screws 104 may be co-rotating screws that rotate in the same direction, such as direction 105 shown in the example of FIG. 1. However, the screws are not limited to rotating in this direction and could rotate in a different direction or rotate in different directions from one another. According to an exemplary embodiment, mixing materials may be fed into screw extruder 100 via an input 106, which feeds the mixing materials to an interior of barrel 102 and to screws 104. For instance, a substantially unfibrillated binder 101 and a carbon material 103 may be provided to input 106, as shown in the exemplary embodiment of FIG. 1. However, as discussed above, other mixing materials may be provided or additional mixing materials may be provided to extruder 100. Screws 104 provide one or more of shear, compression, and tensile forces to the mixing materials and urge the mixing materials along screws 104 and barrel 102 until the mixing materials are extruded through die 108 as an extruded material 109. For instance, when a substantially unfibrillated binder 101 and a carbon material 103 are provided as mixing materials, extruded material 109 may be a carbon electrode material.

Mixing materials may be mixed together before being fed into input 106 or may be separately supplied to input 106. According to an exemplary embodiment, mixing materials may be used in their as-received state, meaning that they are not further treated, such as by solution mixing, sonication, heating, or in-situ polymerization, before mixing with the mixing materials or being supplied to screw extruder 100.

According to an exemplary embodiment, mixing materials may also be added to an interior of barrel 102 during an extrusion process instead of supplying the mixing materials via input 106. For instance, screw extruder 100 may include one or more side stuffers 110 to supply mixing materials to screws 104 after an extrusion process has begun. Side stuffers 110 may be configured to supply mixing materials that are solid and substantially dry. Side stuffers 110 may be provided as a plurality of side stuffers 110 that each contains a single mixing material or one or more side stuffers 110 may include a mixture of two or more mixing materials to be added to an extrusion process. Screw extruder 100 may further include one or more injectors 112 configured to add a liquid, such as an electrolyte or other liquid, to an extrusion process. However, as discussed above, mixing materials are preferably substantially dry from input 106 to die 108 and mixed extruded material exiting die 108 is substantially dry. Therefore, the use of injectors 112 is not necessary in exemplary embodiments in which mixing materials and mixed material is substantially dry.

Mixing materials may be supplied to screw extruder 100 in various orders and combinations. For instance, when screw extruder 100 is used to mix a carbon electrode material comprising activated carbon and PTFE binder, both the activated carbon and the PTFE binder may be supplied to input 106, either previously mixed together or separately supplied. In another example, activated carbon may be supplied to input 106 and PTFE binder may be provided via side stuffer 110 during an extrusion process. In another example, PTFE binder may be supplied to input 106 and activated carbon may be supplied via side stuffer 110 during an extrusion process. In any of these examples, additional activated carbon and/or PTFE binder may be added during an extrusion process, such as via a side stuffer 110.

In another instance, when screw extruder 100 is used to mix a carbon electrode material comprising activated carbon, PTFE binder, and carbon black, the activated carbon, PTFE binder, and carbon black may be supplied to input 106. In such an example, two or more of the mixing materials may be previously mixed before being supplied to input 106, with any remaining mixing material supplied separately, or the mixing materials may be separately supplied to input 106. In another example, PTFE binder and activated carbon may be supplied to input 106 while carbon black is supplied via side stuffer 110. In another example, PTFE binder and carbon black may be supplied to input 106 while activated carbon is supplied via side stuffer 110. In another example, activated carbon and carbon black may be supplied to input 106 while PTFE binder is supplied via side stuffer 110. In another example, PTFE binder may be supplied to input 106 while activated carbon and carbon black are supplied via side stuffer 110. In another example, activated carbon may be supplied to input 106 while PTFE binder and carbon black are supplied via side stuffer 110. In another example, carbon black is supplied via input 106 while PTFE binder and activated carbon are supplied via side stuffer 110. In any of these examples, additional activated carbon, PTFE binder, and/or carbon black may be added during an extrusion process, such as via a side stuffer 110.

According to an exemplary embodiment, extrusion may be performed at a continuous rate under the constant conditions of input rate and screw speed. For instance, mixing materials may be manually or automatically fed into the extruder and extruded at a constant screw speed. According to one example, the screw speed may be selected from the range of about 10 rpm to about 500 rpm. In another example, the screw speed may be in a range of about 10 rpm to about 100 rpm. In another example, the screw speed may be in a range of about 50 rpm to about 60 rpm. In another example, the screw speed may be about 50 rpm.

According to one example, the extrusion may be performed at a temperature in a range of about 0° C. to about 100° C. In another example, extrusion may be performed at a temperature in a range of about 10° C. to about 50° C. In another example, extrusion may be performed at approximately room temperature, or approximately 27° C. Such temperatures may, according to embodiments, refer to a temperature of the mixing materials, i.e., where the mixing materials have been pre-heated prior to extrusion. In related embodiments, such temperatures refer to a temperature of a screw extrusion device, such as, for example, to a temperature to which one or more heating components of an extrusion device has been set.

As discussed above, an extrusion process may be conducted as a substantially dry process. For instance, all mixing materials supplied to an extrusion device may be substantially dry to provide a mixed material that is substantially dry. A consequence of utilizing dry mixing materials is that friction between extruder components and mixing materials may be high in contrast to a mixing process that uses wet mixing materials. As a result, extruder components may be subjected to higher stresses than would occur in a wet process, which could result in higher wear rates for an extruder and possibly contamination from worn extrusion components. To address this, components of an extrusion device may be made of a wear resistant material. According to an exemplary embodiment, extrusion components, such as barrel 102 and/or screws 104, may be made of a wear resistant alloy. For instance, extrusion components may be made of a wear resistant tool steel or a wear resistant stainless steel. For instance, extrusion components may be made of a wear resistant and corrosion resistant alloy comprising about 2.3 wt % carbon, about 20 wt % chromium, about 1% molybdenum, and about 4.2 wt % vanadium. An example of such an alloy is X 235 HTM, which is available from Sintec HTM AG, a Kennametal Company. According to an exemplary embodiment, extrusion components may be coated with a wear resistant coating, such as tungsten carbide, titanium nitride, or other wear resistant coatings.

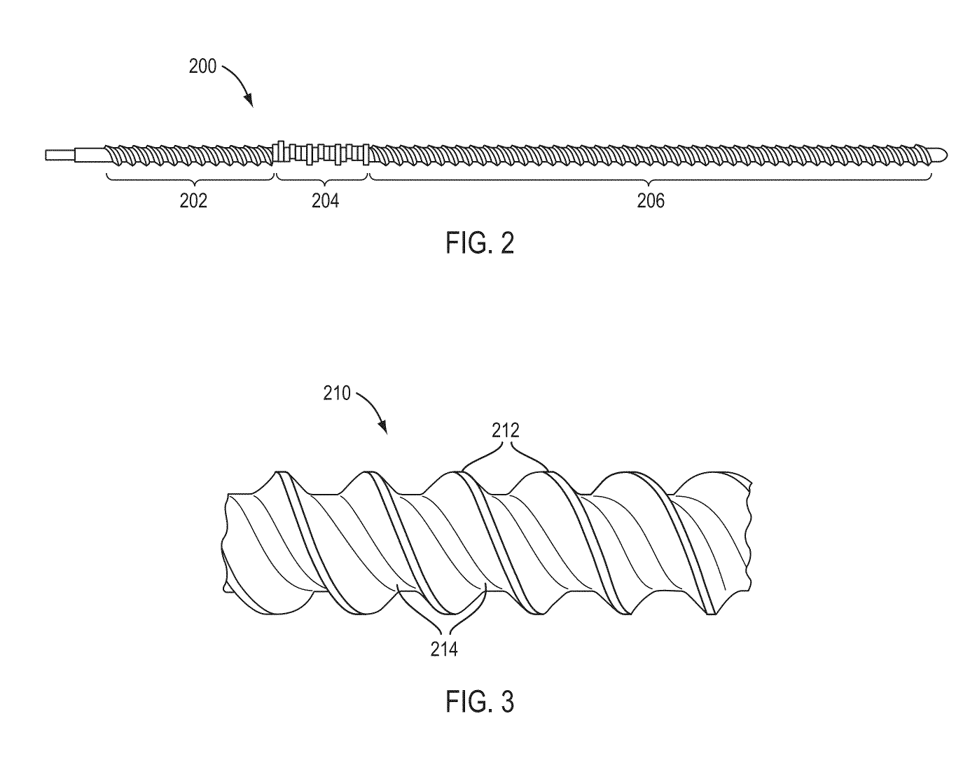

According to an exemplary embodiment, a screw of a screw extruder may include a plurality of portions that may have varying structures. For instance, a screw may be a segmented screw having a plurality of portions. Turning to FIG. 2, an exemplary embodiment of a segmented screw 200 is shown that has a first portion 202, a second portion 204, and a third portion 206. First portion 202 and third portion 206, for example, may be portions of flighted screws. As shown in the exemplary embodiment of FIG. 3, a flighted screw 210 may include flights 212 separated by a trough 214. Flighted screw 210 may be characterized by a pitch length between flights 212 and a radial length of flights 212 relative to a longitudinal axis of a flighted screw 210. In addition, a flighted screw 210 may include a squared region (not shown) on its forward side to increase its screw volume and enhance feeding of mixing materials.

Second portion 204 of segmented screw 200 may include a plurality of kneading blocks. Although the exemplary embodiment shown in FIG. 2 includes one portion of kneading blocks, segmented screw 200 may include multiple portions that include kneading blocks. Kneading block portions may be spaced apart from one another or may be adjacent to one another. For instance, portions of kneading blocks may alternate with portions of flighted screws. According to an exemplary embodiment, portions of kneading blocks may have kneading blocks having the same geometry and/or orientation relative to a longitudinal axis of a screw, or portions may have different kneading blocks.

According to an exemplary embodiment, kneading blocks may be oriented at an angle relative to a longitudinal axis of a screw. For instance, kneading blocks may be oriented at an angle relative to one another when viewed along a longitudinal axis of the segmented screw. Such an angle may be, for example, in a range of about 20° to about 100°.

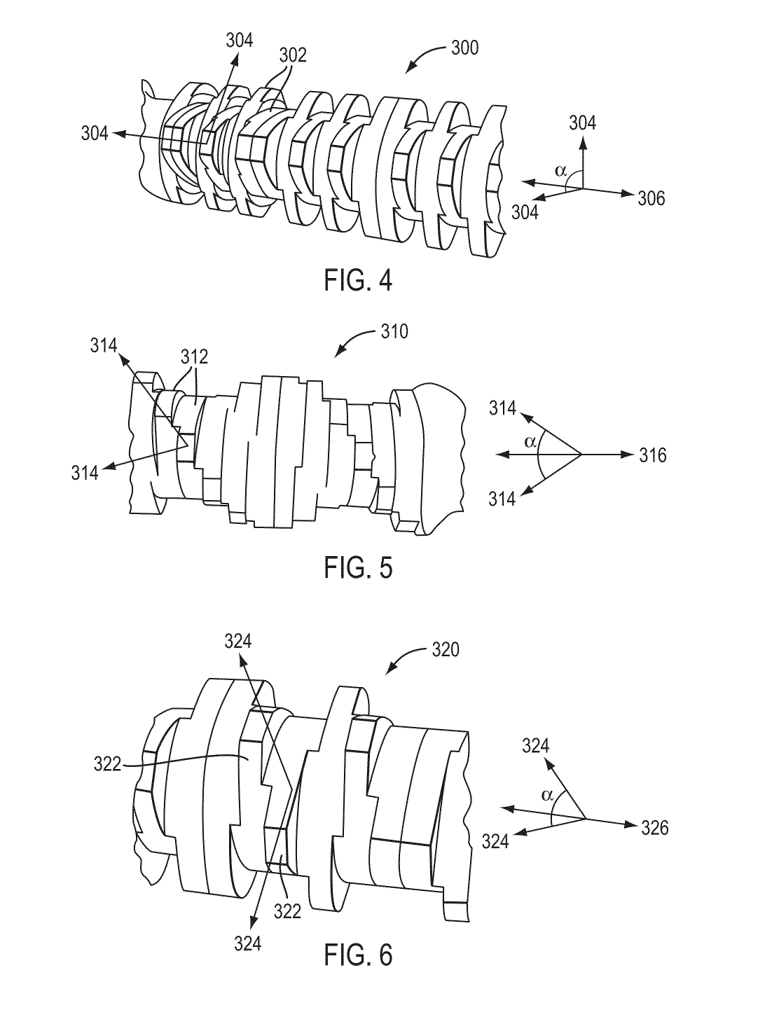

Turning to FIG. 4, an example of a kneading block portion 300 is shown that includes kneading blocks 302 oriented along axes 304 at an angle relative to a longitudinal axis 306 of a screw. In the example shown in FIG. 4, kneading blocks 302 may be oriented along axes 304 that are at an approximately 90° angle a to one another when viewed along the longitudinal axis 36 of a screw. Although kneading blocks 302 would apply forces to mixing materials in a screw extruder, kneading blocks 302 arranged at an angle a of approximately 90° might not apply a strong forward or reverse force to mixing materials and a screw may rely upon other portions, whether flighted screws or different kneading blocks oriented at different angles or otherwise configured to apply a forward or reverse force to mixing materials, to apply forces to advance mixing materials through a screw extruder.

Other kneading block orientations may be used. Turning to FIG. 5, another example of a kneading block portion 310 is shown that includes kneading blocks 312 oriented along axes 314 at an angle a of approximately 30° when viewed along a longitudinal axis 316 of a screw. Kneading blocks 312 arranged at an angle a of approximately 30° may provide a relatively weak advancing force to mixing materials in a screw extruder. Further, FIG. 6 shows an example of a kneading block portion 320 that includes kneading blocks 322 oriented along axes 324 at an angle a of approximately 60° when viewed along a longitudinal axis 326 of a screw. In addition, although the examples shown in FIGS. 4-6 show kneading block portions including kneading blocks oriented at a particular angle, a kneading block portion may include kneading blocks that are oriented at different angles. For instance, a kneading block portion may include kneading blocks oriented at varying degrees within a range of about 20° to about 100°, such as, for example, 30°, 60°, and/or 90°.

According to an exemplary embodiment, once mixed material has exited die 108 of a screw extruder 100, the mixed material may be processed further. For instance, a substantially dry mixed material exiting die 108 may be in the form of dry flakes. According to an exemplary embodiment, the extruded material produced from mixing materials extruded by a screw extruder may be subsequently processed into a sheet, such as when the extruded material is a carbon electrode material. The extruded material may be processed by one or more calendaring processes to form a sheet, as described in U.S. application Ser. No. 12/712,661, filed on Feb. 25, 2010, which is hereby incorporated by reference in its entirety. A calendared material may be calendared to a thickness of, for example, less than 0.01 inches. In another example, a calendared material may have a thickness of less than 0.005 inches. In another example, a calendared material may have a thickness of less than 0.002 inches. In another example, a calendared material may have a thickness of less than 0.0014 inches. In another example, a calendared material may have a thickness of less than 0.0012 inches. In addition, the extruded material may be first ground into a powder after extrusion and before calendaring.

According to an exemplary embodiment, a process of forming an electrode may comprise extruding mixing materials using a twin screw extruder to make a carbon electrode material and calendaring the carbon electrode material to make an electrode material.

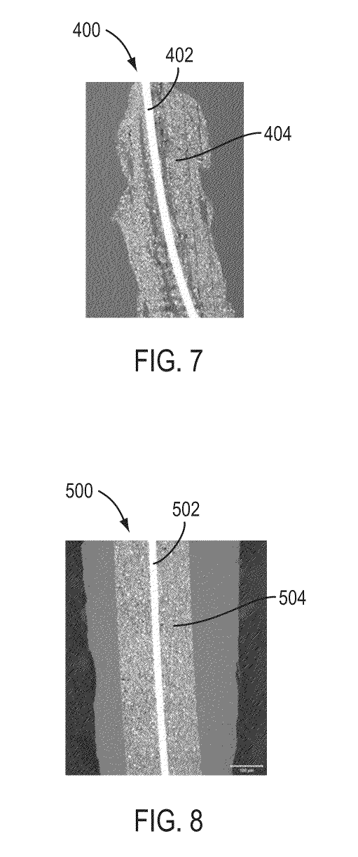

An article formed with material mixed by a dry extrusion process according to the embodiments described above advantageously has desirable mechanical and electrical properties. A fibrillated binder provides good mechanical properties due to the degree and uniformity of fibrillation. For instance, a sheet formed from a carbon electrode material comprising a fibrillated binder may have a burst strength of about 0.18 MPa to about 0.25 MPa, which is approximately twice the strength of a sheet produced from material mixed by a ball mill process. Turning to FIG. 7, a cross section is shown of an electrode 400 that includes a current collector 402 and carbon electrode material 404 produced by a conventional ball mill process. In contrast, FIG. 8 shows a cross section of an electrode 500 that includes a current collector 502 and current electrode material 504 produced by a dry twin screw extruder. As shown in FIG. 8, the carbon electrode material 504 has improved uniformity in its thickness and has lower porosity than the carbon electrode material 404 in FIG. 7.

Further, electrical properties can be improved due to the uniformity and packing arrangement of carbon material within the matrix of binder material.

By mixing materials in a dry extrusion process, a process may be advantageously provided that that is less complex, less costly, and/or less time consuming relative to conventional methods of making mixed materials, such as carbon electrode materials. For instance, a dry extrusion process does not require an additional drying step to remove liquid content from mixed material, while advantageously providing a mixed material with excellent mechanical and electrical properties. In another example, mixing materials may be readily available in the market and/or may not require mixing, crushing, or dispersing, and the mixing and extruding may not require added pressure.

Other embodiments may be considered besides those described above. In at least one exemplary embodiment, the at least one binder of the mixing materials is not plasticized by the shear stresses exerted by the screws of the twin screw extruder. Further, in an exemplary embodiment, the extrusion of the at least one binder does not result in a large number of fibrillized binder particles coalescing and forming substantial agglomeration. Rather, the binder has fibrillized without coalescing, thereby resulting in a substantially uniform distribution of the components in the extruded material.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary. Thus, for example, the use of “the mixing material” or “mixing material” is intended to mean at least one mixing material.

Other embodiments of the invention will be apparent to those skilled in the art from consideration of the specification and practice of the invention disclosed herein. It is intended that the specification and examples be considered as exemplary only, with a true scope and spirit of the disclosure.

### EXAMPLES

The following table provides examples of carbon electrode materials mixed by a twin screw extrusion process according to the parameters provided in the table. The examples are not intended to be limiting of the invention as claimed.

In Table 1, auger speed refers to the rotational speed of a screw, such as the rotational speed of a screw 104 in direction 105 shown in the exemplary embodiment of FIG. 1. Crammer speed refers to the rotational speed of a screw (not shown) that may be provided within a funnel supplying mixing material to a screw extruder. For instance, a crammer may be provided within input 106 shown in the exemplary embodiment of FIG. 1 to urge mixing material into barrel 102 of a screw extruder 100. Feed rate refers to the pounds per hour of mixing material supplied to a screw extruder. Feed length refers to a length of a screw along a longitudinal axis of a screw before a first flighted screw portion commences. First flight length refers to a length of the first flighted screw portion along a longitudinal axis of a screw.

Kneader assemblage refers to the arrangement of kneading block portions. For instance, an assemblage of two sets of 30° kneading blocks and a set of 60° kneading blocks may refer to a first kneading block portion including kneading blocks oriented at a 30° angle to a longitudinal axis of a screw, a second kneading block portion oriented at a 30° angle to the longitudinal axis of the screw, and a third kneading block portion oriented at a 60° angle to the longitudinal axis of the screw in an upstream to downstream direction of the screw (such as in a direction from input 106 to die 109 in the exemplary embodiment of FIG. 1) with the kneading block portions being adjacent to one another. In another instance, an assemblage including two sets of 30° blocks may include two portions of kneading blocks oriented at a 30° angle to a longitudinal axis of a screw, with the kneading block portions arranged adjacent to one another in an upstream to downstream direction. The kneading block portions had a length of about 15 mm along the longitudinal axis of the screw.

TABLE 1

| | | | | | | First | | | |
|---|---|---|---|---|---|---|---|---|---|
| | | Auger | Crammer | Feed | Feed | flight | | | |
| Run | | speed | speed | rate | length | length | Kneader | Alcohol | |
| number | Composition | (RPM) | (RPM) | (lb/h) | (mm) | (mm) | assemblage | injection | |
| 1 | 85% activated | 60 | 20 | 1.1 | 90 | 60 | Two sets of | 0.5 | mL/min |
| | carbon, 5% | | | | | | 30° and a | | |
| | carbon black | | | | | | set of 60° | | |
| | and 10% PTFE | | | | | | kneading | | |
| | | | | | | | blocks | | |
| 2 | 85% activated | 55 | 25 | 1 | 90 | 60 | Two sets of | 0.5 | mL/min |
| | carbon, 5% | | | | | | 30° and a | | |
| | carbon black | | | | | | set of 60° | | |
| | and 10% PTFE | | | | | | kneading | | |
| | | | | | | | blocks | | |
| 3 | 85% activated | 60 | 20 | 1.1 | 90 | 60 | Two sets of | 5 | wt % |
| | carbon, 5% | | | | | | 30° and a | | |
| | carbon black | | | | | | set of 60° | | |
| | and 10% PTFE | | | | | | kneading | | |
| | | | | | | | blocks | | |
| 4 | 85% activated | 55 | 25 | 1 | 90 | 60 | Two sets of | 5 | wt % |
| | carbon, 5% | | | | | | 30° and a | | |
| | carbon black | | | | | | set of 60° | | |
| | and 10% PTFE | | | | | | kneading | | |
| | | | | | | | blocks | | |
| 5 | 85% activated | 60 | 25 | 1.1 | 90 | 60 | Two sets of | 5 | wt % |
| | carbon and 15% | | | | | | 30° and a | | |
| | PTFE | | | | | | set of 60° | | |
| | | | | | | | kneading | | |
| | | | | | | | blocks | | |
| 6 | 90% activated | 50 | 70 | 1 | 90 | 60 | Two sets of | 5 | wt % |
| | carbon and 10% | | | | | | 30° and a | | |
| | PTFE | | | | | | set of 60° | | |
| | | | | | | | kneading | | |
| | | | | | | | blocks | | |
| 7 | 85% activated | 50 | 25 | 1 | 90 | 60 | Two sets of | 0.5 | mL/min |
| | carbon and 15% | | | | | | 30° | | |
| | PTFE | | | | | | kneading | | |
| | | | | | | | blocks | | |
| 8 | 85% activated | 50 | 25 | 1 | 90 | 60 | A set of 60° | 0.5 | mL/min |
| | carbon and 15% | | | | | | kneading | | |
| | PTFE | | | | | | blocks | | |
| 9 | 85% activated | 40 | 120 | 0.9 | 90 | 60 | Two sets of | 0 | mL/min |
| | carbon, 5% | | | | | | 30° and a | | |
| | carbon black | | | | | | set of 60° | | |
| | and 10% powder | | | | | | kneading | | |
| | PTFE | | | | | | blocks | | |

What is claimed:

1. A method of forming a carbon electrode material, comprising:
providing substantially dry mixing materials to a twin screw extruder, wherein the mixing materials comprise substantially unfibrillated binder and a carbon material; and
extruding the mixing materials via a twin screw extruder to form a substantially dry carbon electrode material comprising a fibrillated binder.

2. The method of claim 1, wherein the substantially dry mixing materials include a maximum liquid content of about 5 wt. %.

3. The method of claim 1, wherein the substantially dry mixing materials include a maximum liquid content of about 0 wt. %.

4. The method of claim 1, wherein the carbon material comprises activated carbon and the substantially unfibrillated binder comprises polytetrafluoroethylene.

5. The method of claim 4, wherein the mixing materials further comprise carbon black.

6. The method of claim 1, wherein the binder and the carbon material are mixed prior to providing the binder and the carbon material to the twin screw extruder.

7. The method of claim 1, wherein one of the binder and the carbon material are added to material that is already being processed by the twin screw extruder.

8. The method of claim 1, further comprising adding an additional mixing material to material that is already being processed by the twin screw extruder.

9. The method of claim 1, wherein the twin screw extruder includes a segmented screw.

10. The method of claim 9, wherein the segmented screw comprises kneading blocks.

11. The method of claim 10, wherein the kneading blocks are oriented at an angle relative to one another along a longitudinal axis of the segmented screw, wherein the angle ranges from about 20° to about 100°.

12. The method of claim 1, wherein the carbon material is activated carbon having an average particle diameter ranging from about 1 μm to about 10 μm.

13. The method of claim 1, wherein the mixing materials further comprise a second binder.

14. The method of claim 1, wherein the extruding is performed at a temperature in a range of about 0° C. to about 100° C.

15. A method of extruding a dry mixture, comprising:
providing mixing materials to a twin screw extruder, wherein the mixing materials are substantially dry; and
extruding the mixing materials via the twin screw extruder to form an extruded mixture that is substantially dry.

16. The method of claim 15, wherein the extruded mixture comprises one or more of a carbon material, a binder, carbon black, talc particulates, precursors for pharmaceutical medicines or products, and mixtures thereof.

17. The method of claim 15, wherein the mixing materials comprise a substantially unfibrillated binder and activated carbon.

18. The method of claim 15, wherein the mixing materials include a maximum liquid content of about 5 wt. %.

19. The method of claim 15, wherein the mixing materials include a maximum liquid content of about 0 wt. %.

20. A method of forming a carbon electrode material, comprising:
providing substantially dry mixing materials to a twin screw extruder, wherein the mixing materials comprise substantially unfibrillated binder and a carbon material;
extruding the mixing materials via a twin screw extruder to form a substantially dry carbon electrode material comprising a fibrillated binder; and
calendaring the substantially dry carbon electrode material into an electrode material.
